(19) United States
(12) Patent Application Publication
(10) Pub. No.: US 2009/0004451 A1
(43) Pub. Date: Jan. 1, 2009

(54) Thin Magnetic Films

(76) Inventors: John Michael Coey, Dublin (IE); Munuswamy Venkatesan, Dublin (IE); Ciara Bridget Fitzgerald, County Meath (IE)

Correspondence Address: JACOBSON HOLMAN PLLC, 400 SEVENTH STREET N.W., SUITE 600, WASHINGTON, DC, 20004, US

(21) Appl. No.: 11/658,613

(22) PCT Filed: Jul. 28, 2005
(86) PCT No.: PCT/IE05/00079

§ 371 Date: Feb. 22, 2008

(30) Foreign Application Priority Data
Jul. 28, 2004 (IE) 2004/0510

(51) Int. Cl. H01F 10/10

(52) U.S. Cl. 428/220; 428/692.1; 428/336; 428/469; 428/693.1

(57) ABSTRACT

A composite comprises a substrate and a fluoride, oxide, nitride or boride of a substantially non-magnetic cation on the substrate, the composite exhibiting ferromagnetic properties at room temperature. The composite may be in the form of a film.

### INTRODUCTION

The invention relates to a composite such as a magnetic film. In particular, this invention relates to a magnetic film for use, for example in a new generation of spin electronic devices.

Magnetic oxides are widely used in high frequency components, electronmagnetic drives, magnetic recording media and permanent magnets. The materials used frequently belong to the spinel ferrite, hexagonal ferrite or garnet families. A common feature of all known magnetically-ordered oxides is that they incorporate metal cations from a transition series of the periodic table. These cations are usually from the 3d series, and they have a partially-filled 3d shell. The most common magnetic cation is Fe³⁺. Other 3d cations commonly found in ferromagnetic, antiferromagnetic or ferrimagnetic oxides include Cr³⁺, Mn²⁺, Mn³⁺, Mn⁴⁺, Fe²⁺, Co²⁺, Co²⁺ and Ni²⁺. Occasionally magnetic ions from the 4d, 4f or 5d series may be included in magnetically ordered oxides. An example is the garnet Gd₃Fe₅O₁₂ which contains both Gd³⁺ and Fe³⁺ ions. The net ferromagnetic moment of a magnetically-ordered ionic compound cannot exceed the sum of the spin-only moments of the constituent magnetic cations, calculated according to Hund's first rule.

Magnetic thin films for practical applications are usually composed of a metallic ferromagnetic alloy based on iron, cobalt or nickel. An example is permalloy Fe₂₁Ni₇₉. The films find application in magnetic sensors and in magnetic recording, both in the read/write heads and as magnetic recording media. Thin film stacks are structured to form a variety of devices including spin valves and magnetic tunnel junctions which are the basis of present-day spin electronic technology (1).

Some oxides notably AlOₓ or MgO play a part as tunnel barrier in magnetic thin film stacks. Others such as SiO₂ are used as protective layers. These oxides are not themselves magnetic.

Matsumoto and coworkers (2) show that titanium dioxide containing a few percent of cobalt is ferromagnetic at room temperature. Reports in Applied Physics Letters and elsewhere show that TiO₂ in either the rutile or anatase form, ZnO, SnO₂ and Cu₂O are ferromagnetic in thin film form when they contain a magnetic cation of transition-metal such as vanadium; manganese, iron, cobalt or nickel. In some cases the ferromagnetism was shown to be associated with the presence of cobalt as a secondary phase. These data are reviewed by Prellier et al (3).

This invention is aimed at providing composites and especially magnetic thin films with improved properties.

### STATEMENTS OF INVENTION

According to the invention there is provided a composite comprising:—
a substrate; and
a fluoride, oxide, nitride or boride of a substantially non-magnetic cation on the substrate;
the composite exhibiting ferromagnetic properties at room temperature.

In one embodiment the material on the substrate is in the form of a film. The film may have a thickness of from 1 to 1000 nm.

In one embodiment the cation is selected from an element of the first six groups of the periodic table.

In one case the material on the substrate is HfO₂, ZrO₂, CeO₂, Ta₂O₅, Nb₂O₅ or WO₃.

In one embodiment the cation is a dopant material in an oxide of groups IIB, IIA or IVA of the periodic table. The dopant may be Sc. The oxide containing the dopant may be ZnO, CdO, HgO, Al₂O₃, Ga₂O₃, In₂O₃, Ti₂O₃, SiO₂, GeO₂, SnO, PbO or PbO₂.

In one embodiment the substrate is in the form of a wafer.

The substrate may be transparent.

The substrate may be crystalline or amorphous.

In one case the substrate is conducting.

In another case the substrate is insulating.

In one embodiment the substrate is of Al₂O₃, MgO, ZnO, SrTiO₃, MgAl₂O₄ or yttrium-stabilized zirconia.

The substrate may be of Si, Ge, GaAs or InSb.

In one embodiment the substrate includes a buffer which may comprise a buffer layer on the surface of the substrate. The buffer may be of an oxide such as SiO₂, Al₂O₃ or MgO. Alternatively the buffer is metallic such as of Cu, Ta, V or Ti.

The composite of the invention may have a magnetic moment in the range 10 to 1000 Bohr magnetons per square nanometer of substrate area. The composite may have a magnetic moment in the range 10 to 1000 Bohr magnetons per square nanometer of substrate area which is more than five times the spin-only moment attributable to any magnetic impurity ions in the substrate, especially magnetic cations with partially-filled d or f shells in the substrate/film.

In one embodiment the composite comprises fluoride, oxide, nitride or boride and a substrate or buffer layer of Si, Ge, GaAs or InSb.

In another embodiment the composite has a magnetic moment in the range 10-1000 Bohr magnetons per square nanometer of substrate area which is more than ten times the spin-only moment attributable to any magnetic impurity ions in the substrate/film.

The substrate may be Al₂O₃, MgO, ZnO, SrTiO₃, MgAl₂O₄ or yttrium-stabilized zirconia and the oxide may be any one or more of HfO₂, ZrO₂ CeO₂, CdO, Ta₂O₅, Nb₂O₅ or WO₃.

In one embodiment the fluoride, oxide, nitride or boride is deposited on the substrate. The deposition may be a physical or chemical deposition such as pulsed-laser deposition, sputtering, molecular-beam epitaxy, ion beam deposition, metal organic chemical vapour deposition or spray pyrolysis.

In one embodiment the composite is in the form of a film.

In one aspect the invention provides a thin film comprising a fluoride, oxide, nitride or boride deposited on a substrate or buffer layer which exhibits ferromagnetic properties at room temperature with a magnetic moment in the range 10 to 1000 Bohr magnetons per square nanometer of substrate area which is more than five times the spin-only moment attributable to any magnetic cations with partially-filled d or f shells in the film.

In another aspect the invention provides a thin film comprising HfO₂, ZrO₂, CeO₂, Ta₂O₅, Nb₂O₅ or WO₃ having thickness in the range 1 to 1000 nm deposited on a transparent crystalline or amorphous substrate of Al₂O₃, MgO, ZnO, SrTiO₃, MgAl₂O₄ or yttrium-stabilized zirconia which exhibits ferromagnetic properties at room temperature with a magnetic moment in the range 10 to 1000 Bohr magnetons per square nanometer of substrate area which is more than ten times the spin-only moment attributable to any magnetic impurity ions in the film.

In a further aspect the invention provides a thin film comprising a fluoride, oxide, nitride or boride deposited on a substrate or buffer layer of Si, Ge, GaAs or InSb with film thickness in the range 1 to 1000 nm which exhibits ferromagnetic properties at room temperature with a magnetic moment in the range 10-1000 Bohr magnetons per square nanometer of substrate area which is more than five times the spin-only moment attributable to any magnetic impurity ions in the film.

In another aspect the invention provides a thin film having a film thickness in the range 1 to 1000 nm of a complex oxide composed of oxides which are not magnetically ordered in the bulk which exhibits ferromagnetic properties at room temperature with a magnetic moment in the range 10 to 1000 Bohr magnetons per square nanometer of substrate area which is more than ten times the spin-only moment attributable to any magnetic impurity ions in the film.

The invention also provides a device, such as a magnetic thin film device, comprising a composite or film of the invention.

### BRIEF DESCRIPTION OF THE FIGURES

The invention will be more clearly understood from the following description thereof given by way of example only with reference to the accompanying figures in which:

FIG. 1 are graphs showing the typical magnetisation curves of the films of the invention on different substrates. The substrates are (a) R-cut sapphire (b) C-cut sapphire, (c) yttria stabilized zirconia (YSZ) and (d) silicon. The oxide is HfO₂. In the figures the black dot is where the magnetic field is perpendicular to the film plane and the white dot is where the magnetic field is parallel to the film plane;

FIG. 2 is a magnetisation curve for a thin film of ZrO₂ produced on a substrate of R-cut sapphire.

FIG. 3 are graphs of (a) scandium-doped ZnO, (b) vanadium-doped ZnO and (c) cobalt-doped ZnO deposited by pulsed laser deposition from a target of composition (M_{0.05}Zn_{0.95})O where M=Sc, V or Co, onto a substrate of R-cut sapphire maintained at 700° C. The black dot is where the magnetic field is perpendicular to the film plane and the white dot is where the magnetic field is parallel to the film plane;

FIG. 4 are magnetisation curves taken at room temperature for a) for a blank Al₂O₃ substrate, b) for a CaB₆ film on Al₂O₃ and c) for the film after subtracting the substrate signal; and

FIG. 5 are magnetisation curves for SrB₆ on an MgO substrate, with the field applied perpendicular or parallel to the substrate.

### DETAILED DESCRIPTION

Ions of main group elements such as Ca²⁺, Sr²⁻ or O²⁻ and ions with filled d or f shells such as Zn²⁺, Zr⁴⁺, He⁴⁺ contain no unpaired electron spins and have hitherto been regarded as unsuitable as the major constituent of any magnetic material whether in bulk or in thin film form.

The invention relates to oxides and other ionic compounds which are substantially or entirely free of metallic cations with partially-filled d or f shells. The oxides or other ionic compounds need not contain the transition metal cations with unfilled 3d, 4d or 4f shells which have previously been regarded as a prerequisite for the formation of a magnetically-ordered state.

We have found that suitably-prepared thin films of these oxides are magnetic at ambient temperature and above. These magnetic thin films may have properties such as transparency and/or semiconducting behaviour which will facilitate practical applications. Thin film devices made with the magnetic films of the invention have potential for integration with semiconductor electronics and/or optics in a new generation of spin electronic devices.

Examples of films which are ferromagnetic at room temperature include HfO₂, ZrO₂ WO₃, CaB₆ and SrB₆ on sapphire or silicon. The magnetic moment of the films in the range 10-1000 Bohr magnetons per square nanometer of film area is governed by the substrate used and the growth conditions of the film.

Thin films of an oxide which is nonmagnetic in bulk form are prepared on a nonmagnetic substrate. It is the combination of thin-film oxide and substrate that leads to the magnetic properties of the oxide. The magnetism of the films depend on the film/substrate combination. The oxide need not contain any transition metal ions, although small concentrations (less than 1 atomic %) may be present in commercially-available raw materials. Substrates may be transparent crystals of oxides such as Al₂O₃ (sapphire), MgO, yttria-stabilized zirconia (YSZ), MgAl₂O₄, SrTiO₃ and others. Wafers of semiconductors such as silicon, gallium arsenide or gallium nitride are also suitable as substrates. Alternatively, the oxide film may be grown on a buffer layer which is deposited or created on a substrate by chemical or thermal treatment. The oxide or other ionic compound is of an element taken from the first six columns of the periodic table. Examples are MgO, CaO, SrO, BaO, CdO, Sc₂O₃, Y₂O₃, La₂O₃, TiO₂, ZrO₂, HfO₂. V₂O₅, Nb₂O₅, Ta₂O₅ and WO₃ and any solid solution, mixture or compound thereof. Various oxide/substrate combinations lead to a room temperature ferromagnetic response. Some examples are given in the next section.

The thin film deposition method may be a physical or chemical deposition method such as pulsed-laser deposition, sputtering, molecular-beam epitaxy, ion beam deposition, metal organic chemical vapour deposition or spray pyrolysis. These methods are known in the art of thin film fabrication. The results vary with the deposition method. Important parameters for pulsed-laser deposition include the ambient atmosphere in the deposition chamber, the laser fluence on the target, the deposition rate, the substrate temperature and any post-deposition thermal treatment. In the case of sputtering, important parameters include the ambient pressure in the deposition chamber, the sputtering rate, substrate bias, substrate temperature and any post-deposition thermal treatment.

Unlike bulk magnetic materials and most ferromagnetic films of thickness greater than a few nanometers where the magnetic moment of the film scales with the volume of material, the magnetic moment of the magnetic thin films of the invention may scale with the area or the volume of the film. Values range from about ten to about one thousand Bohr magnetons (μ_{B}) per square nanometer of surface area.

In addition to magnetism at room temperature, the magnetic thin films of the invention may exhibit another unusual property namely anisotropy of the magnetization. Normally the magnetization of a ferromagnetic film will saturate at the same value regardless of the orientation of the magnetic field with respect to the substrate. The approach to saturation will be influenced by shape anisotropy and anisotropy of magnetocrystalline origin, but the saturation magnetization is independent of direction to better than 5%. In contrast the saturation magnetization in the films of the invention varies with direction of the applied field with respect to the substrate. Variations of up to 400% are observed between the smallest and greatest values of saturation magnetization of the films. This anisotropy may be exploited in magnetosensitive devices and sensors. It may also be used to exert torques and otherwise in micro-electromechanical systems (MEMS).

An important property of the ferromagnetic oxide films of the invention is transparency at optical wavelengths enabling magneto-optical effects to be exploited.

The thin films of the invention, oxides, fluorides, nitrides and borides of cations having an electronic configuration with no unpaired d or f electrons in partially-filled shells have widespread use in spin electronic and magneto-optic devices. These include, but are not limited to, sensors, magnetic logic and memory elements and signal processing devices. In some cases, for example HfO₂ films, compatibility with silicon-based electronics has already been established, as HfO₂ is being actively researched as a high-k dielectric layer, thereby facilitating the integration of magnetic functionality with silicon-based electronic structures.

The magnetic thin films of the invention are oxides or other ionic compounds which need not contain the transition metal cations with unfilled 3d, 4d or 4f shells which were regarded, prior to this invention, as a prerequisite for the formation of a magnetically-ordered state. The magnetism depends on the film/substrate combination. Examples of films which are ferromagnetic at room temperature include HfO₂, ZrO₂, WO₃. CaB₆ and SrB₆ on sapphire or silicon The magnetic moment of the films in the range 10-1000 Bohr magnetons per square nanometer of film area is governed by the substrate used and the growth conditions of the film.

The invention will be more fully understood by reference to the following examples.

### EXAMPLE 1

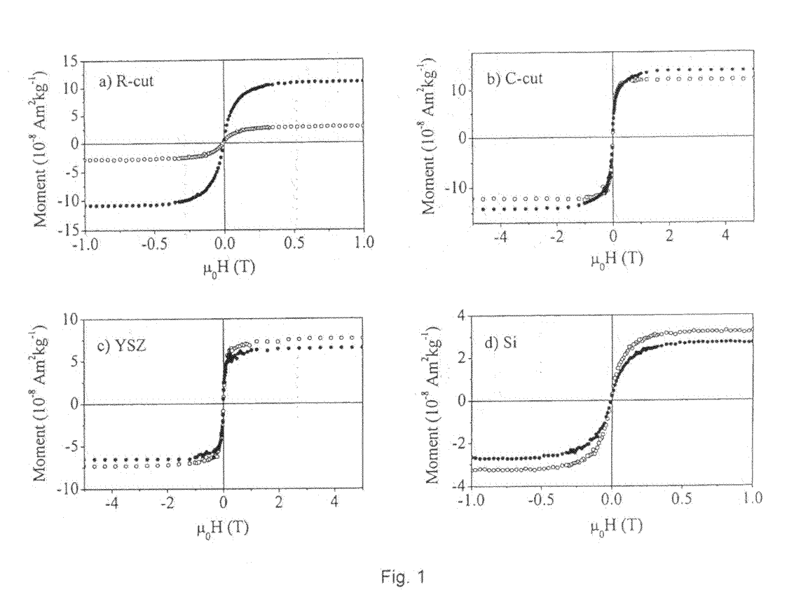

Films of HfO₂ were deposited on various substrates by means of pulsed-laser deposition. The films were produced from a ceramic target of HfO₂ using a KrF excimer laser. The substrate was maintained at a temperature in the range 600-900° C. Typical magnetisation curves of the thin films which are corrected for the diamagnetic background due to the substrate and addenda are shown in FIG. 1. The substrates used are R-cut sapphire, C-cut sapphire, silicon or YSZ. Film thickness was in the range 1-1000 nm. FIG. 1 includes magnetization curves with the field applied either parallel (∥) or perpendicular (⊥) to the substrate which establish that the anisotropy of the magnetization depends on the substrate. Generally on R-cut sapphire the perpendicular magnetization is the greater whereas on YSZ or Si the parallel magnetization is the greater.

The magnetic moment is present even in very thin films, of thickness 10 nm or less. The moment of the film is proportional to the substrate area. Typical values lie in the range 100-500 Bohr magnetons per square nanometer (μ_{B}/nm²).

The magnetic moment depends on the rate of deposition of the film. HfO₂ films of similar thickness show a greater moment when they are deposited in a similar way at 1 Hz than at 10 Hz, where the frequency refers to the number of laser pulses incident on the target per second.

Table 1 is a summary of data based on Hafnium dioxide films.

TABLE 1

| | | Temp | Time | | Freq | Thickness | σ_{⊥} | σ_{//} | σₒᵥ | σₒᵥ |
|---|---|---|---|---|---|---|---|---|---|---|
| No. | Substrate | ° C. | (mins) | Target | (Hz) | (nm) | (10⁻⁸Am²) | (10⁻⁸Am²) | (10⁻⁸Am²) | (μ₈nm-²) |
| 1 | RS | 750 | 15.0 | 1 | 10.0 | 80 | 10.8 | 2.7 | 5.4 | 253 |
| 2 | RS | 750 | 15.0 | 1 | 10.0 | 82 | 6.7 | 5.1 | 5.6 | 263 |
| 3 | RS | 750 | 15.0 | 1 | 10.0 | 82 | 9.0 | 3.5 | 5.3 | 253 |
| 4 | Si | 750 | 7.5 | 1 | 10.0 | 82 | 4.2 | — | 4.2 | 197 |
| 5 | RS | 750 | 22.5 | 1 | 10.0 | 45 | 2.9 | 2.2 | 2.4 | 117 |
| 6 | RS | 750 | 15.0 | 1 | 10.0 | 121 | 3.2 | 1.5 | 2.1 | 98 |
| 7 | RS | 750 | 2.5 | 2 | 10.0 | 187 | 7.1 | 6.3 | 6.6 | 309 |
| 8 | RS | 750 | 15.0 | 2 | 10.0 | 31 | 7.3 | 6.5 | 6.8 | 319 |
| 9 | Si | 750 | 6.0 | 2 | 10.0 | 187 | 2.7 | 3.2 | 3.0 | 141 |
| 10 | RS | 750 | 10.0 | 2 | 10.0 | 75 | 2.8 | 2.0 | 2.3 | 108 |
| 11 | RS | 750 | 20.0 | 2 | 10.0 | 125 | 3.0 | 2.4 | 2.6 | 122 |
| 12 | RS | 750 | 15.0 | 2 | 10.0 | 245 | 1.1 | — | 1.1 | 52 |
| 13 | CS | 750 | 15.0 | 2 | 10.0 | 400 | 14.5 | 19.0 | 17.5 | 821 |
| 14 | RS | 700 | 15.0 | 2 | 10.0 | 187 | 2.7 | 2.4 | 2.5 | 117 |
| 15 | RS | 850 | 15.0 | 2 | 10.0 | 187 | 4.5 | 2.0 | 2.8 | 131 |
| 16 | YSZ | 770 | 15.0 | 2 | 10.0 | 192 | 6.4 | 7.6 | 7.2 | 338 |
| 17 | YSZ | 700 | 15.0 | 2 | 10.0 | 192 | 1.9 | 2.6 | 2.4 | 113 |
| 18 | CS | 770 | — | 2 | 1.0 | 0.6 | <0.1 | — | — | <5 |
| 19 | CS | 770 | 1.0 | 2 | 2.5 | 3.0 | 2.6 | 3.4 | 3.1 | 145 |
| 20 | CS | 770 | 10.0 | 2 | 1.0 | 12.8 | 35.0 | 28.3 | 30.5 | 1449 |
| 21 | CS | 770 | 1.0 | 2 | 10.0 | 12.6 | 8.3 | 7.0 | 7.4 | 347 |
| 22 | CS | 770 | 4.0 | 2 | 10.0 | 51 | 14.0 | 11.9 | 12.6 | 591 |
| 23 | RS | 700 | 15.0 | 3 | 10.0 | — | 1.1 | — | 1.1 | 51 |
| 24 | RS | 700 | 15.0 | 4 | 10.0 | — | 1.2 | — | 1.2 | 57 |
| 25 | RS | 700 | 15.0 | 5 | 10.0 | — | 1.0 | — | 1.0 | 47 |

| | | | |
|---|---|---|---|
| Key: | Substrates. | Key: | Targets. |
| RS | R-cut Sapphire | 1 | HfO₂ 98% purity. |
| CS | C-cut Sapphire | 2 | HfO₂ 99.95% purity. |
| Si | Silicon | 3 | (Hf_{0.95}Sc_{0.05})O₂ 99% purity. |
| YSZ | Yttrium | 4 | (Hf_{0.95}Ti_{0.05})O₂ 99% purity. |
| | | 5 | (Hf_{0.95}Ta_{0.05})O₂ 99% purity. |

### EXAMPLE 2

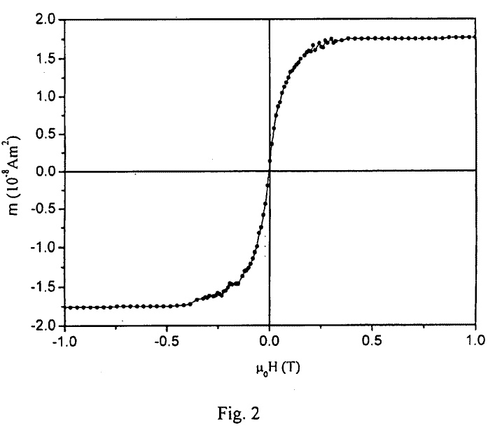

A thin film of ZrO₂ is produced on a substrate of R-cut sapphire maintained at 700° C. during pulsed-laser deposition. The film showed a ferromagnetic magnetization curve, like those of HfO₂, with a saturation moment of 120 μ_{B}/nm². (FIG. 2)

### EXAMPLE 3

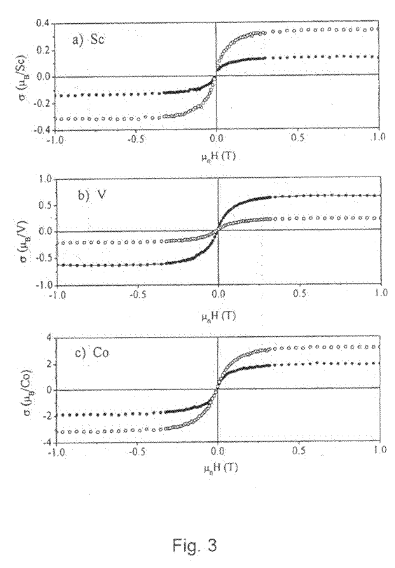

A thin film of scandium-doped ZnO is deposited by pulsed laser deposition from a target of composition (Sc_{0.05}Zn_{0.95})O onto a substrate of R-cut sapphire maintained at 700° C. The magnetization is anisotropic, being much greater when the field is applied perpendicular to the film than it is in the parallel direction, as shown in FIG. 3a. The conductivity of the zinc oxide can be varied by means of the oxygen pressure in the deposition chamber. Films with similar properties can be prepared with scandium or other dopant cations using sputtering or pulsed-laser deposition. Data is shown for ZnO similarly doped with vanadium in FIG. 3(b) or cobalt in FIG. 3(c). V³⁺ and Co²⁺ are magnetic cations, but Sc³⁺ is not. Comparison of scandium and vanadium in this example shows that it is possible to achieve comparable moments in the presence or absence of a magnetic dopant cation.

### EXAMPLE 4

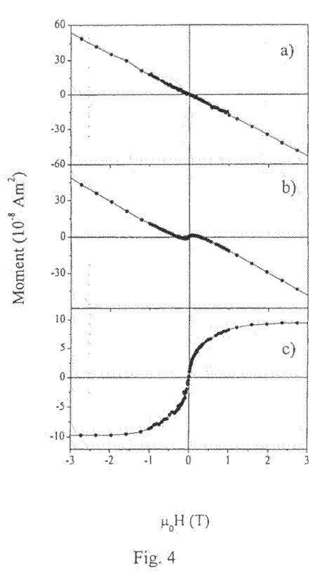

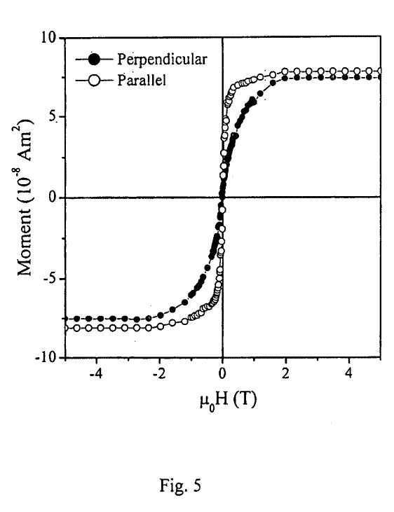

Thin films of the borides CaB₆, SrB₆, BaB₆ and SrB₆ were prepared by pulsed laser deposition on substrates of C-cut sapphire (FIG. 4) or MgO (FIG. 5). The substrates were maintained at 600° C., and film thickness was in the range 10 to 25 nm. These films also exhibit ferromagnetic magnetization curves, and the anisotropy is again dependent on the substrate/Film choice. The first curve (a) in FIG. 4 shows the diamagnetism of a blank Al₂O₃ substrate subjected to the same thermal cycle in the deposition chamber as one with a thin film deposited on it (FIG. 4b). The room-temperature magnetization curve of the thin film shown in FIG. 4c was obtained after subtracting off the diamagnetic background due to the substrate (FIG. 4b-FIG. 4a)

FIG. 5 shows the anisotropy of the magnetization of a film of SrB₆ on MgO (measured with magnetic field parallel and perpendicular directions to the film plane). Generally no hysteresis is observed in the room-temperature magnetization curves. A demagnetizing effect is evident in the perpendicular magnetization curves, as seen in FIG. 5, which is consistent with the magnetization of a non-uniform thin film.

Some results of the magnetic moments of boride thin films (μ_{B} nm⁻²) are summarized in Table 2. The magnetization in the table is given in units of Bohr magnetons per square nanometer (nm) of substrate area. The magnetization of very thin films, less than 10 nm in thickness is comparable in magnitude to that of metallic nickel.

These films are insulating in the as-deposited state, but may be made electrically conducting by heat treatment in vacuum, typically at 900° C. for 30 minutes.

TABLE 2

| Film | Substrate | Moment (μ_{B} nm⁻²) |
|---|---|---|
| CaB₆ | MgO | 136 |
| CaB₆ | C-cut sapphire | 555 |
| SrB₆ | MgO | 226 |
| SrB₆ | C-cut sapphire | 240 |

While we do not wish to be bound by theory we believe that the very surprising magnetic properties of the composites and films of the invention may be due to atomic mismatch at the interface between the substrate and the material on the substrate.

The invention is not limited to the embodiments hereinbefore described, with reference to the accompanying drawings, which may be varied in detail.

### REFERENCES

1. Spin Electronics, M. Ziese and M. J. Thornton, editors; Springer Verlag Berlin 2001
2. Matsumoto et al, Science 292, 854, 2001
3. Prellier, Fouchet and Mercey, Journal of Physics, Condensed Matter 15, R1583, 2003.

1-34. (canceled)

35. A composite comprising:—
a substrate; and
a fluoride, oxide, nitride or boride of a substantially non-magnetic cation on the substrate;
the composite exhibiting ferromagnetic properties at room temperature.

36. The composite as claimed in claim 35 wherein the material on the substrate is in the form of a film.

37. The composite as claimed in claim 36 wherein the film has a thickness of from 1 to 1000 nm.

38. The composite as claimed in claim 35 wherein the cation is selected from an element of the first six groups of the periodic table.

39. The composite as claimed in claim 35 wherein the material on the substrate is selected from any one or more of HfO₂, ZrO₂, CeO₂, Ta₂O₅, Nb₂O₅ or WO₃.

40. The composite as claimed in claim 35 wherein the cation is a dopant material in an oxide of groups IIB, IIA or IVA of the periodic table.

41. The composite as claimed in claim 40 wherein the dopant is Sc.

42. The composite as claimed in claim 40 wherein the oxide containing the dopant is selected from any one or more of ZnO, CdO, HgO, Al₂O₃, Ga₂O₃, In₂O₃, Ti₂O₃, SiO₂, GeO₂, SnO, PbO or PbO₂.

43. The composite as claimed in claim 35 wherein the substrate is in the form of a wafer.

44. The composite as claimed in claim 35 wherein the substrate is transparent.

45. The composite as claimed in claim 35 wherein the substrate is crystalline.

46. The composite as claimed in claim 35 wherein the substrate is amorphous.

47. The composite as claimed in claim 35 wherein the substrate is conducting.

48. The composite as claimed in claim 35 wherein the substrate is insulating.

49. The composite as claimed in claim 35 wherein the substrate is selected from any one or more of Al₂O₃, MgO, ZnO, SrTiO₃, MgAl₂O₄ or yttrium-stabilized zirconia.

50. The composite as claimed in claim 35 wherein the substrate is selected from any one or more of Si, Ge, GaAs or InSb.

51. The composite as claimed in claim 35 wherein the substrate includes a buffer which may comprise a buffer layer on the surface.

52. The composite as claimed in claim 51 wherein the buffer is of an oxide is selected from any one or more of SiO₂, Al₂O₃ or MgO.

53. The composite as claimed in claim 51 wherein the buffer is metallic which may be selected from any one or more of Cu, Ta, V or Ti.

54. The composite as claimed in claim 35 having a magnetic moment in the range 10 to 1000 Bohr magnetons per square nanometer of substrate area.

55. The composite as claimed in claim 35 having a magnetic moment in the range 10 to 1000 Bohr magnetons per square nanometer of substrate area which is more than five times the spin-only moment attributable to any magnetic cations with partially-filled d or f shells in the film.

56. The composite as claimed in claim 35 having a magnetic moment in the range 10 to 1000 Bohr magnetons per square nanometer of substrate area which is more than five times the spin-only moment attributable to any magnetic impurity ions in the film.

57. The composite as claimed in claim 56 comprising fluoride, oxide, nitride or boride and a substrate or buffer layer selected from any one or more of Si, Ge, GaAs or InSb.

58. The composite as claimed in claim 35 having a magnetic moment in the range 10 to 1000 Bohr magnetons per square nanometer of substrate area which is more than ten times the spin-only moment attributable to any magnetic impurity ions in the film.

59. The composite as claimed in claim 58 wherein the substrate is selected from any one or more of Al₂O₃, MgO, ZnO, SrTiO₃, MgAl₂O₄ or yttrium-stabilized zirconia and the oxide is selected from any one or more of HfO₂, ZrO₂, CeO₂, Ta₂O₅, Nb₂O₅ or WO₃

60. The composite as claimed in claim 35 wherein the fluoride, oxide, nitride or boride is deposited on the substrate.

61. The composite as claimed in claim 60 wherein the deposition is a physical or chemical deposition such as pulsed-laser deposition, sputtering, molecular-beam epitaxy, ion beam deposition, metal organic chemical vapour deposition or spray pyrolysis.

62. The composite as claimed in claim 35 in the form of a film.

63. A thin film comprising a fluoride, oxide, nitride or boride deposited on a substrate or buffer layer which exhibits ferromagnetic properties at room temperature with a magnetic moment in the range 10 to 1000 Bohr magnetons per square nanometer of substrate area which is more than five times the spin-only moment attributable to any magnetic cations with partially-filled d or f shells in the film.

64. A thin film comprising HfO₂, ZrO₂, CeO₂, Ta₂O₅, Nb₂O₅ or WO₃ having thickness in the range 1 to 1000 nm deposited on a transparent crystalline or amorphous substrate selected from any one or more of Al₂O₃, MgO, ZnO, SrTiO₃, MgAl₂O₄ or yttrium-stabilized zirconia which exhibits ferromagnetic properties at room temperature with a magnetic moment in the range 10 to 1000 Bohr magnetons per square nanometer of substrate area which is more than ten times the spin-only moment attributable to any magnetic impurity ions in the film.

65. A thin film comprising a fluoride, oxide, nitride or boride deposited on a substrate or buffer layer of Si, Ge, GaAs or InSb with film thickness in the range 1 to 1000 nm which exhibits ferromagnetic properties at room temperature with a magnetic moment in the range 10 to 1000 Bohr magnetons per square nanometer of substrate area which is more than five times the spin-only moment attributable to any magnetic impurity ions in the film.

66. A thin film having a film thickness in the range 1 to 1000 nm of a complex oxide composed of oxides which are not magnetically ordered in the bulk in the bulk which exhibits ferromagnetic properties at room temperature with a magnetic moment in the range 10 to 1000 Bohr magnetons per square nanometer of substrate area which is more than ten times the spin-only moment attributable to any magnetic impurity ions in the film.

67. The device comprising a composite as claimed in claim 35.

68. The device comprising a film as claimed in claim 63.

69. The device comprising a film as claimed in claim 64.

70. The device comprising a film as claimed in claim 65.

71. The device comprising a film as claimed in claim 66.

72. The magnetic thin film device comprising a composite as claimed in claim 35.

73. The magnetic thin film device comprising a film as claimed in claim 63.

74. The magnetic thin film device comprising a film as claimed in claim 64.

75. The magnetic thin film device comprising a film as claimed in claim 65.

76. The magnetic thin film device comprising a film as claimed in claim 66.
